(19) United States
(12) Patent Application Publication
(10) Pub. No.: US 2010/0328973 A1
(43) Pub. Date: Dec. 30, 2010

(54) AC COUPLED SWITCHING POWER SUPPLY AND METHOD THEREFOR

(76) Inventors: Benedict C.K. Choy, Cupertino, CA (US); Scott Lynch, Half Moon Bay, CA (US); Rex Caballero, Cupertino, CA (US)

Correspondence Address: WEISS & MOY PC, 4204 NORTH BROWN AVENUE, SCOTTSDALE, AZ, 85251, US

(21) Appl. No.: 12/492,994

(22) Filed: Jun. 26, 2009

(51) Int. Cl. H02M 7/219; H02H 7/125

(52) U.S. Cl. 363/52; 363/89

(57) ABSTRACT

A circuit for converting high voltage AC to low voltage DC has an input capacitor coupled an input AC source. A rectifier is coupled to the input capacitor. A switch is coupled to the rectifier. A voltage regulator is coupled to the switch. The voltage regulator regulates an output of the circuit by closing the switch when a rising edge of a rectified AC voltage is below an output voltage and opens the switch when the output voltage reaches a regulation voltage. A storage capacitor is coupled to the switch.

### FIELD OF THE INVENTION

This invention relates generally to a power supply, and more particularly, to a circuit and method of converting high voltage AC to low voltage DC using a capacitive coupler and a switched power supply.

### BACKGROUND OF THE INVENTION

There are devices such as consumer appliances and electronics, i.e. refrigerators, washing machines, dishwashers, microwave ovens, etc., which require high voltage AC power and low voltage DC power. The low voltage DC requirement is for powering analog and digital control circuitry, display indicators such as Light Emitting Diodes and other low power device. To convert high voltage AC power to low voltage DC power, different devices may be used. For example, a switching step-down or Buck converter, a linear power supply with a step-down transformer, or a switching power supply may be used for the above purpose.

While each of the above devices do work to provide a low voltage DC power from a high voltage AC power input, they each have different issues. The Buck converter provides good efficiency and lower standby power consumption. However, it has high frequency switching noise conducted back to the line. The linear power supply with a step-down transformer may be low noise, but it is very bulky and inefficient. Many switching power supplies gives very low standby power consumption, but it draws high peak currents from the line and is not as efficient as the Buck converter.

Therefore, a need existed to provide a system and method to overcome the above problem.

### SUMMARY OF THE INVENTION

A circuit for converting high voltage AC to low voltage DC has an input capacitor coupled an input AC source. A rectifier is coupled to the input capacitor. A switch is coupled to the rectifier. A voltage regulator is coupled to the switch. The voltage regulator regulates an output of the circuit by closing the switch when a rising edge of a rectified AC voltage is below an output voltage and opens the switch when the output voltage reaches a regulation voltage. A storage capacitor is coupled to the switch.

The present invention is best understood by reference to the following detailed description when read in conjunction with the accompanying drawings.

### BRIEF DESCRIPTION OF THE DRAWINGS

FIG. 1 is a prior art switching power supply;

FIG. 2 is a graph showing expected waveforms from operation of the switching power supply of FIGS. 1;

FIG. 3 is a prior art capacitor coupled power supply;

FIG. 4 is a graph showing expected waveforms from the capacitor coupled power supply depicted in FIG. 3;

FIG. 5 is a switching power supply of the present invention; and

FIG. 6 is a graph showing expected waveforms from the switching power supply depicted in FIG. 5.

Common reference numerals are used throughout the drawings and detailed description to indicate like elements.

### DETAILED DESCRIPTION

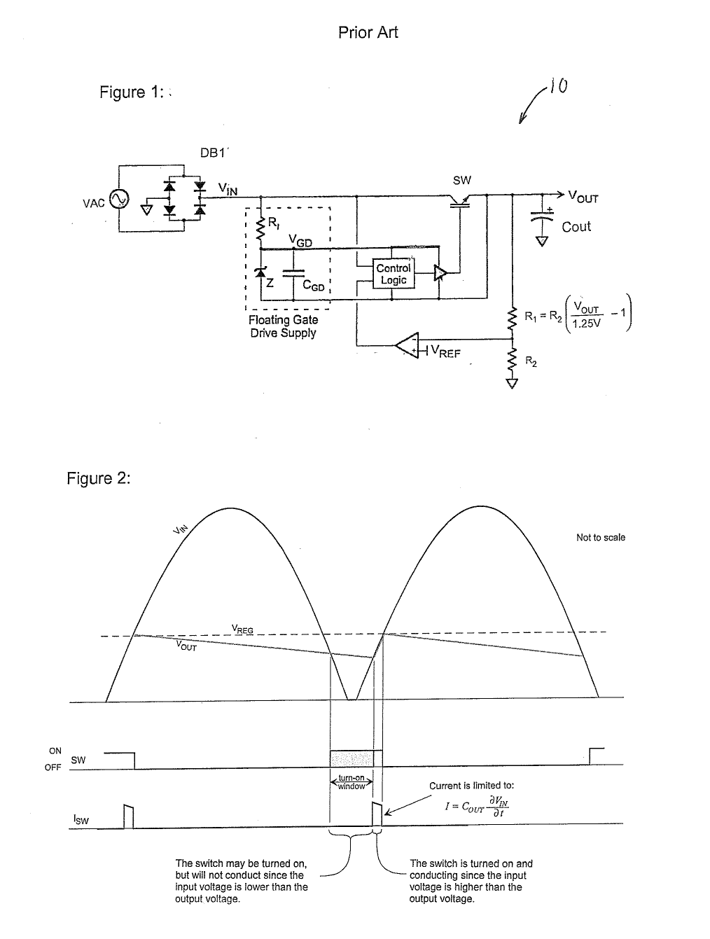

Referring to FIG. 1, a prior art switching power supply 10 is shown. The switching power supply 10 monitors the rectified AC (Vin) and turns the switch (SW) only when the rising edge of the rectified AC (Vin) is below the output voltage (Vout). The switch (SW) is turned off when the output voltage (Vout) reaches regulation point. When the switch (SW) is turned off, the output capacitor supplies current to the load. The detailed description of the operation of the switching power supply 10 is disclosed in U.S. Pat. No. 7,330,364.

As may be seen in the waveforms shown in FIG. 2, when the switch (SW) is closed, the charging current (Isw) can be several amperes since the output storage capacitor (Cout) is being peak charged back to regulation. This high charging current (Isw) creates substantial dynamic and static losses across the switch (SW) lowering the overall efficiency of the switching power supply 10. The charging current (Isw) may present unwanted noise on the line which may result in elevated conducted emissions. Further, the bridge rectifier (DB1) and switch (SW) need to be able to handle the peak charging current (Isw) which will require these components to be bigger and more expensive. The two main shortcomings of the switching power supply 10 are high peak currents and lower efficiency. The power losses are mainly due to the high charging current which increases the static and dynamic loss of the switch (SW).

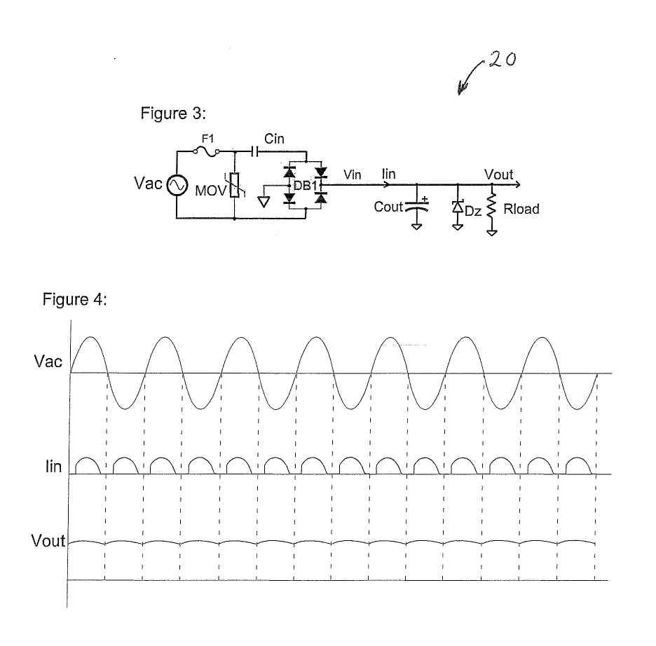

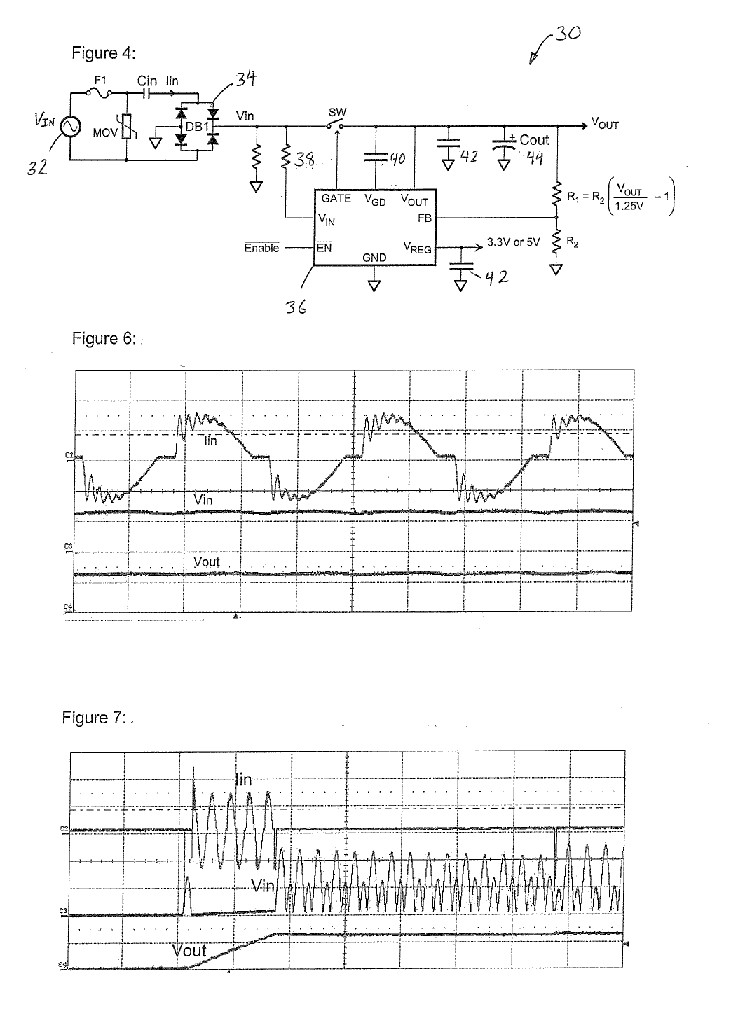

Referring now to FIG. 3, a prior art basic capacitor coupled power supply 20 is shown. This capacitor coupled power supply 20 does not have high peak currents, but its output voltage (Vout) regulation is loose and its no-load (standby) power consumption is high. Further, this capacitor coupled power supply 20 is inefficient since it always consumes full load current (Iin) regardless of the actual load consumption as shown in FIG. 4.

Referring to FIG. 5, a switching power supply 30 of the present invention is shown. The switching power supply 30 allows one to attain low standby power consumption, higher efficiency, and low conducted emissions. This is accomplished by combining the capacitor coupled power supply with the switching power supply as illustrated in FIG. 5.

As shown in FIG. 5, the switching power supply 30 has an AC power supply 32 having an input voltage V_{IN}. The AC power supply 32 is a sinusoidal AC voltage typically in the range of 50-60 Hz and either 110-120 VAC or 220-240 VAC. A rectifier 34 is coupled to the AC power supply 32. The rectifier 34 is used for converting the AC input voltage V_{IN} to a DC voltage. In accordance with one embodiment, the rectifier 44 is a full bridge rectifier. A fuse F1 is coupled in series with the AC power supply 32. A varistor MOV is coupled to the fuse F1 and to the AC power supply 32. The varistor MOV is a solid state device used to protect against high voltage transients spikes. A capacitive element Cin is coupled to the Fuse F1, the varistor MOV and to the rectifier 34. The capacitive element Cin may be a film capacitor.

A switch SW1 is coupled to the rectifier 34. The switch SW1 may be an N-Channel MOSFET, N-Channel IGBT, a Polypropylene capacitor, or the like. The listing of the above is given as examples and should not be seen in a limiting scope. The switch SW1 is also coupled to an output GATE of the switching regulator 36. A resistive element 38 is coupled to an input V_{IN} of the switching regulator 36 and the switch SW1. A capacitive element 40 is coupled to an input VGD of the switching regulator 36 and to the switch SW1. Capacitive elements 42 and 44 are coupled to an output V_{OUT} of the switching regulator 36. An input FB of the switching regulator 36 is coupled to a voltage divider circuit defined by resistors R1 and R2. An input V_{REG} of the switching regulator 36 is coupled to a regulated voltage and to a capacitive element 42.

In this embodiment, the switching regulator 32, along with the switch (SW), comprise as a series switching regulator as opposed to the shunt regulator Dz shown in FIG. 3.

As shown in FIG. 5, the series input capacitor (Cin) acts as a capacitive divider with the output load (Rload). At full load condition, the switch (SW) is mostly on. As shown in FIG. 6, the switch (SW) has low voltage drop across it and is conducting low amplitude, almost sinusoidal current (Iin) to the output capacitor (Cout) and the load (Rload). Most of the line voltage is dropped across the input capacitor (Cin). Since the switch current is low, its dynamic and static losses are minimized increasing the efficiency of the power supply. The fuse (F1), bridge rectifier (DB1), and switch (SW) can now have lower current ratings which allow the use of smaller and cheaper components. Also, since the line current is almost sinusoidal (non-switching), noise is at the very minimum. FIG. 6 shows the actual waveforms captured from the circuit shown in FIG. 5 at full load.

FIG. 7 shows the actual waveforms captured from the circuit in FIG. 5 at light loads. During this light load condition, the switch (SW) conducts momentarily to keep the Vout in regulation. The rest of the time, the output capacitor supplies current to the load. The duty cycle and the amplitude of the line current at light load is very low making the standby power consumption low as well.

The input power is limited by the value of the Cin capacitor, input voltage, and the frequency of the line.

While embodiments of the disclosure have been described in terms of various specific embodiments, those skilled in the art will recognize that the embodiments of the disclosure can be practiced with modifications within the spirit and scope of the claims.

What is claimed is:

1. A circuit for converting high voltage AC to low voltage DC comprising:
an input capacitor coupled an input AC source;
a rectifier coupled to the input capacitor;
a switch coupled to the rectifier;
a voltage regulator coupled to the switch, the voltage regulator regulates an output of the circuit by closing the switch when a rising edge of a rectified AC voltage is below an output voltage and opens the switch when the output voltage reaches a regulation voltage; and
a storage capacitor coupled to the switch.

2. A circuit for converting high voltage AC to low voltage DC in accordance with claim 1 wherein the switch is a transistor.

3. A circuit for converting high voltage AC to low voltage DC in accordance with claim 1 wherein the switch is an N-channel transistor.

4. A circuit for converting high voltage AC to low voltage DC in accordance with claim 1 wherein the switch is an N-channel IGBT.

5. A circuit for converting high voltage AC to low voltage DC in accordance with claim 1 wherein the input capacitor acts as a capacitive divider with an output load.

6. A circuit for converting high voltage AC to low voltage DC in accordance with claim 1 further comprising a fuse coupled in series with the an input capacitor and the input AC source.

7. A circuit for converting high voltage AC to low voltage DC in accordance with claim 1 further comprising a varistor coupled to the input capacitor and the rectifier.

8. A circuit for converting high voltage AC to low voltage DC in accordance with claim 1 wherein the rectifier is a full bridge rectifier.

9. A circuit for converting high voltage AC to low voltage DC comprising:
an input capacitor coupled an input AC source, the input capacitor acing as a capacitive divider with an output load;
a full bridge rectifier coupled to the input capacitor;
a switch coupled to the full bridge rectifier;
a voltage regulator coupled to the switch, the voltage regulator regulates an output of the circuit by closing the switch when a rising edge of a rectified AC voltage is below an output voltage and opens the switch when the output voltage reaches a regulation voltage; and
a storage capacitor coupled to the switch.

10. A circuit for converting high voltage AC to low voltage DC in accordance with claim 9 wherein the switch is a transistor.

12. A circuit for converting high voltage AC to low voltage DC in accordance with claim 9 wherein the switch is an N-channel transistor.

13. A circuit for converting high voltage AC to low voltage DC in accordance with claim 9 wherein the switch is an N-channel IGBT.

14. A circuit for converting high voltage AC to low voltage DC in accordance with claim 9 further comprising a fuse coupled in series with the the input capacitor and the input AC source.

15. A circuit for converting high voltage AC to low voltage DC in accordance with claim 9 further comprising a varistor coupled to the input capacitor and the rectifier.

16. A circuit for converting high voltage AC to low voltage DC in accordance with claim 1 wherein the input capacitor is a film capacitor.

17. A circuit for converting high voltage AC to low voltage DC comprising:
an input capacitor coupled an input AC source, the input capacitor acing as a capacitive divider with an output load;
a full bridge rectifier coupled to the input capacitor;
a fuse coupled in series with the the input capacitor and the input AC source;
a varistor coupled to the input capacitor and the rectifier;
a switch coupled to the full bridge rectifier;
a voltage regulator coupled to the switch, the voltage regulator regulates an output of the circuit by closing the switch when a rising edge of a rectified AC voltage is below an output voltage and opens the switch when the output voltage reaches a regulation voltage; and
a storage capacitor coupled to the switch.

18. A circuit for converting high voltage AC to low voltage DC in accordance with claim 17 wherein the switch is a transistor.

19. A circuit for converting high voltage AC to low voltage DC in accordance with claim 17 wherein the switch is an N-channel transistor.

20. A circuit for converting high voltage AC to low voltage DC in accordance with claim 17 wherein the input capacitor is a film capacitor.
